(19) United States
(12) Patent Application Publication
(10) Pub. No.: US 2025/0383509 A1
(43) Pub. Date: Dec. 18, 2025

(54) FIBER OPTIC CONNECTORS AND FIBER OPTIC CONNECTION SYSTEMS

(71) Applicant: CommScope Technologies LLC, Hickory, NC (US)

(72) Inventors: Yu LU, Eden Prairie, MN (US); Ryan KOSTECKA, Waconia, MN (US)

(73) Assignee: CommScope Technologies LLC, Hickory, NC (US)

(21) Appl. No.: 19/107,699

(22) PCT Filed: Aug. 24, 2023
(86) PCT No.: PCT/US2023/072821

§ 371 Date: Feb. 28, 2025

Related U.S. Application Data
(60) Provisional application No. 63/402,230, filed on Aug. 30, 2022.
(60) Provisional application No. 63/436,267, filed on Dec. 30, 2022.

(51) Int. Cl. G02B 6/38

(52) U.S. Cl. CPC G02B 6/3825; G02B 6/3831; G02B 6/3849

(57) ABSTRACT

A fiber optic adapter assembly including a main body having a first end defining a ruggedized connector port and a second end defining a non-ruggedized connector port, and a retention collar configured to mount over an exterior of the main body, wherein one or more features defined by the retention collar interact with a coupling arrangement inserted into the retention collar to shift the retention collar axially relative to the main body from an extended position to a retracted position, whereupon rotation of the coupling arrangement relative to the retention collar from a non-interlocked position to an interlocked position axially shifts the retention collar relative to the main body back to the extended position, thereby inhibiting back rotation of the coupling arrangement from the interlocked position to the non-interlocked position.

### CROSS-REFERENCE TO RELATED APPLICATIONS

This application is being filed on Aug. 24, 2023, as a PCT International application and claims the benefit of and priority to U.S. Provisional Application No. 63/402,230, filed Aug. 30, 2022, and claims the benefit of U.S. Provisional Application 63/436,267, filed Dec. 30, 2022, the disclosures of which are hereby incorporated by reference in their entireties.

### TECHNICAL FIELD

The present disclosure relates generally to fiber optic connectors. More particularly, the present disclosure relates to systems for making fiber optic connectors, and fiber optic connectors made from such systems.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors enable two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule supports the end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut each other. The ferrules are then forced proximally against the bias of their respective springs within their connector housings. \. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Examples of ruggedized fiber optic connection systems are disclosed in U.S. Pat. Nos. 7,467,896; 7,744,288; and 8,556,520.

It will be appreciated that a number of different types of ruggedized fiber optic connectors are available for outside environmental use. International Publication Nos. WO2015/028433; WO2020/236512; and WO2021/041305 disclose systems for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter.

### SUMMARY

Embodiments of the present disclosure provide a fiber-optic connector adapter assemblies configured to optically couple a ruggedized pre-terminated fiber optic cable to a non-ruggedized pre-terminated fiber optic cable, wherein connection of the ruggedized fiber-optic cable to the adapter assembly involves inserting a distal end of the ruggedized fiber-optic into a portion of the adapter assembly, whereupon a portion of the ruggedized fiber-optic cable contacts a retention collar, thereby shifting the retention collar from an extended position to a retracted position, against a natural bias of a spring. Thereafter, partial rotation of the ruggedized fiber-optic cable relative to the adapter assembly between a non-interlocked position and an interlocked position, causes interlocking of one or more features of a coupling interface formed between interior and exterior coupling arrangements of the ruggedized fiber-optic cable and the adapter assembly. The partial rotation of the ruggedized fiber-optic cable relative to the adapter assembly towards the interlocked position further enables the retention collar to return to the extended position under the natural bias of the spring, thereby inhibiting the ruggedized fiber-optic cable from rotating back to the non-interlocked position. Thereafter, rotation of the ruggedized fiber-optic cable relative to the adapter assembly from the interlocked position to the non-interlocked position requires that the retention collar be manually moved against a natural bias of the spring from the extended position to the retracted position.

Accordingly, embodiments of the present disclosure provide an adapter assembly having a coupling interface including a retention collar that is configured to automatically engage with a ruggedized fiber-optic cable upon mating of the ruggedized fiber-optic cable with the adapter assembly, thereby enabling selective locking of the ruggedized fiber-optic cable in the interlocked position relative to the adapter assembly. Moreover, embodiments of the present disclosure enable selective locking of the coupling interface with a single hand, whereas to the extent that assemblies of the prior art provided structure configured to inhibit inadvertent rotation back to the non-interlocked position, said assemblies would require two-handed operation; specifically, during the interlocking process a user would need to manually manipulate the adapter assembly with one hand while simultaneously rotating the ruggedized fiber-optic cable with the other hand. Accordingly, embodiments of the present disclosure provide a more efficient adapter assembly configured to enable a secure connection to be made between a ruggedized fiber-optic cable and an adapter assembly with a single hand.

One embodiment of the present disclosure provides a fiber optic adapter assembly including a main body having a first end defining a ruggedized connector port and a second end defining a non-ruggedized connector port, and a retention collar configured to mount over an exterior of the main body, wherein one or more features defined by the retention collar interact with a coupling arrangement inserted into the retention collar to shift the retention collar axially relative to the main body from an extended position to a retracted position, whereupon rotation of the coupling arrangement relative to the retention collar from a non-interlocked position to an interlocked position axially shifts the retention collar relative to the main body back to the extended position, thereby inhibiting back rotation of the coupling arrangement from the interlocked position to the non-interlocked position.

In one embodiment, the fiber-optic adapter assembly further includes a biasing element configured to bias the retention collar to the extended position. In one embodiment, the biasing element comprises a coil spring. In one embodiment, the retention collar defines a flange positioned on a distal end of the retention collar to aid manipulation of the retention collar from the extended position to the retracted position. In one embodiment, the flange defines one or more grooves to further aid in manipulation of the retention collar.

In one embodiment, the retention collar generally comprises a tubular structure having an interior wall and an exterior wall, wherein the interior wall defines a ridge oriented substantially orthogonal to a longitudinal axis of the retention collar. In one embodiment, the one or more features extend distally from the ridge. In one embodiment, the one or more features are keyed to mirror a keyed distal end of the coupling arrangement, such that rotation of the coupling arrangement relative to the retention collar enables the one or more features to slide axially relative to the keyed distal end of the coupling arrangement. In one embodiment, the fiber-optic adapter assembly further includes one or more anti-rotation tabs extending proximally from the ridge, the one or more anti-rotation tabs reside within one or more channels defined by the main body to inhibit rotation of the retention collar relative to the main body.

In one embodiment, the main body is of a one-piece molded construction. In one embodiment, the non-ruggedized connector port is adapted to receive at least one of a non-ruggedized SC or LC connector. In one embodiment, the ruggedized connector port is adapted to receive a pre-terminated fiber optic cable.

In one embodiment, the ruggedized connector port provides a first interlock function and a second interlock function. In one embodiment, the first interlock function includes a snap-fit feature adapted to engage with a ramped snap-fit feature of the pre-terminated fiber optic cable, wherein as the pre-terminated fiber optic cable is rotated relative to the fiber optic adapter, the ramped snap-fit feature of the pre-terminated fiber optic cable rides over the snap-fit feature of the fiber optic adapter causing the feature to deflect radially inwardly to allow the ramped snap-fit feature to move past the snap-fit feature, whereupon the pre-terminated fiber optic cable reaches a coupled rotational position and the ramped snap-fit feature moves past the snap-fit feature such that the snap-fit feature elastically returns to its non-deflected position. In one embodiment, the snap-fit feature is a permanent interlock, requiring the snap-fit feature to be broken to rotate the pre-terminated fiber optic cable from the interlocked position to the non-interlocked position. In one embodiment, the snap-fit feature is a multi-use interlock configured to deform without breaking to allow movement of the pre-terminated fiber optic cable from the interlocked position to the non-interlocked position. In one embodiment, the second interlock function includes a plurality of triangular projections spaced uniformly along the circumference of the first end.

In one embodiment, the main body includes a flange and an exterior threaded portion, wherein the mounting opening is defined through a wall, and wherein when the main body is mounted within the mounting opening, the wall is compressed between the flange and a nut threaded on the exterior threaded portion. In one embodiment, the fiber-optic adapter assembly further includes a seal positionable between the flange and the wall. In one embodiment, the fiber optic adapter assembly further includes a dust cap adapted to be secured over the first end of the main body to selectively enclose the ruggedized connector port.

In one abundant, the main body defines a keyway for receiving an elongate key defined by a pre-terminated fiber optic cable. In one embodiment, the keyway is defined by two helical shoulders that rotate in opposite helical directions about a central longitudinal axis of the main body. In one embodiment, the helical shoulders provide for rotational guiding of the pre-terminated fiber optic cable as the pre-terminated fiber optic cable is inserted into the ruggedized connector port along a rotational range of movement of at least about 180 degrees, 170 degrees, 135 degrees, 90 degrees, or 45 degrees.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is an exploded, perspective view depicting a fiber-optic connector adapter assembly coupling a ruggedized fiber-optic cable to a non-ruggedized fiber-optic cable, in accordance with an embodiment of the disclosure.

FIG. 2 is an exploded, perspective view depicting a ruggedized fiber-optic cable, in accordance with an embodiment of the disclosure.

FIG. 3 is a perspective view depicting the assembled ruggedized fiber-optic cable of FIG. 2, in accordance with an embodiment of the disclosure.

FIG. 4 is a perspective view depicting the coupling arrangements of a fiber-optic connector assembly and a ruggedized fiber-optic cable, in accordance with an embodiment of the disclosure.

FIG. 4A is a perspective view depicting a coupling arrangement of a ruggedized fiber-optic cable, in accordance with an embodiment of the disclosure.

FIG. 5 is an exploded, perspective view depicting a fiber-optic adapter assembly, in accordance with an embodiment of the disclosure.

FIG. 6 is a cross-sectional view depicting a fiber-optic adapter assembly, in accordance with an embodiment of the disclosure.

FIG. 7 is a profile view depicting a fiber-optic adapter assembly including a retention collar in a retracted position, in accordance with an embodiment of the disclosure.

FIG. 8 is a profile view depicting the fiber-optic adapter assembly of FIG. 7, with the retention collar in the extended position, and accordance with an embodiment of the disclosure.

FIG. 9 is an end view depicting an interaction between a retention collar of a fiber-optic adapter assembly and a keyed distal end of a ruggedized fiber-optic cable, wherein the interaction axially shifts the retention collar to a retracted position, in accordance with an embodiment of the disclosure.

FIG. 10 is an end view depicting an interaction between a retention collar of a fiber-optic adapter assembly and a keyed distal end of a ruggedized fiber-optic cable, wherein the interaction enables the retention collar to shift to the extended position, thereby inhibiting back rotation of the ruggedized fiber-optic cable.

FIGS. 11-14 are perspective views of a retention collar, in accordance with an embodiment of the disclosure.

FIG. 15 is a perspective view depicting a retention collar and main adapter body including anti-rotation tabs and channels to inhibit rotation of the retention collar relative to the main adapter body, in accordance with an embodiment of the disclosure.

FIG. 15A is a perspective view depicting a fiber-optic adapter assembly including a retention collar, in accordance with an embodiment of the disclosure.

FIG. 15B is an end view depicting the fiber-optic adapter assembly of FIG. 15A, in accordance with an embodiment of the disclosure.

FIGS. 16-17 are cross-sectional views of a main adapter body including a keyway and one or more helical shoulders, in accordance with an embodiment of the disclosure.

FIG. 18 is an exploded perspective view depicting adapter assembly in accordance with an alternative embodiment of the disclosure.

FIGS. 19-25 are perspective views of a retention spring collar, in accordance with a second embodiment of the disclosure.

FIGS. 26-32 are perspective views of a retention spring collar, in accordance with a third embodiment of the disclosure.

FIGS. 33-39 are perspective views of a retention spring collar, in accordance with a fourth embodiment of the disclosure.

FIGS. 40-46 are perspective views of a retention spring collar, in accordance with a fifth embodiment of the disclosure.

FIGS. 47-53 are perspective views of a retention spring collar, in accordance with a sixth embodiment of the disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

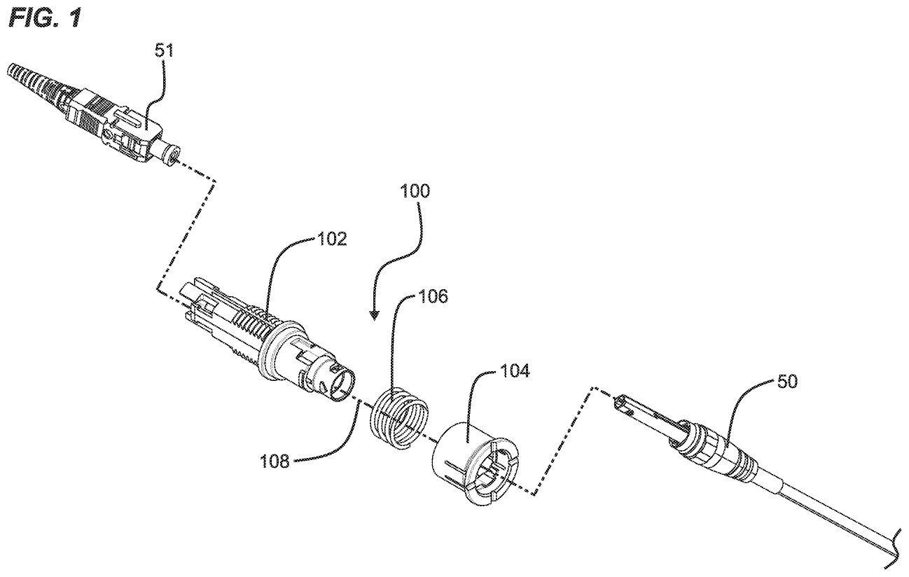

Referring to FIG. 1, a fiber-optic connector adapter assembly 100, occasionally referred to herein as an “adapter assembly” or “adapter,” configured to optically couple a ruggedized connector 50 (e.g., a pre-terminated fiber optic cable connector) to a non-ruggedized connector 51 (e.g., a non-ruggedized pre-terminated fiber optic cable connector), is depicted in accordance with an embodiment of the disclosure. In embodiments, the adapter assembly 100 can include a main adapter body 102 and a retention collar 104. In embodiments, the retention collar 104 can be axially shiftable relative to the main adapter body 102 between an extended position and a retracted position along a central axis of the adapter assembly 100, wherein the retention collar 104 is spring biased, for example via a spring 106, to the extended position.

In operation, connection of the ruggedized connector 50 to the adapter assembly 100 involves inserting a distal end of the ruggedized connector 50 into a portion of the adapter assembly 100, whereupon a portion of the ruggedized connector 50 contacts the retention collar 104, thereby shifting the retention collar 104 from the extended position to the retracted position, against a natural bias of the spring 106. Thereafter, partial rotation of the ruggedized connector 50 relative to the adapter assembly 100 between a non-interlocked position and an interlocked position, causes interlocking of one or more features of a coupling interface formed between interior and exterior coupling arrangements of the ruggedized connector 50 and the adapter assembly 100. The partial rotation of the ruggedized connector 50 relative to the adapter assembly 100 towards the interlocked position enables the retention collar 104 to return to the extended position under the natural bias of the spring 106, which in turn inhibits the ruggedized connector 50 from rotating back to the non-interlocked position.

Thereafter, rotation of the ruggedized connector 50 relative to the adapter assembly 100 from the interlocked position to the non-interlocked position requires that the retention collar 104 be manually moved against a natural bias of the spring 106 from the extended position to the retracted position. Thus, the retention collar 104 serves as a locking mechanism to inhibit inadvertent separation of the ruggedized connector 50 from the adapter assembly, by requiring that the retention collar 104 be manually shifted from the naturally biased extended position to the retracted position before the ruggedized connector 50 can be rotated from the interlocked position to the non-interlocked position.

Accordingly, embodiments of the present disclosure provide an adapter assembly 100 having a coupling interface including a retention collar 104 that is configured to automatically engage with a ruggedized connector 50 upon mating of the ruggedized connector 50 with the adapter assembly 100, thereby enabling selective locking of the ruggedized connector 50 in the interlocked position relative to the adapter assembly 100. Moreover, embodiments of the present disclosure enable selective locking of the coupling interface with a single hand, whereas to the extent that assemblies of the prior art provided structure configured to inhibit inadvertent rotation back to the non-interlocked position, these assemblies of the prior art would require two-handed operation; specifically, during the interlocking process a user would need to manually manipulate the adapter assembly with one hand while simultaneously rotating the ruggedized fiber-optic cable with the other hand. Accordingly, embodiments of the present disclosure provide a more efficient adapter assembly 100 configured to enable a secure connection to be made between a ruggedized connector 50 and an adapter assembly 100 with a single hand.

Embodiments of the present disclosure further provide separation of the ruggedized connector 50 from the adapter assembly 100 with a single hand, as a user can manually shift the retention collar 104 from the extended position to the retracted position against the natural bias of the spring 106 with the same hand used to rotate the ruggedized connector 50 from the interlocked position to the non-interlocked position, thereby enabling decoupling of the ruggedized connector 50 from the adapter assembly 100. Accordingly, it will be appreciated that in addition to other aspects of the disclosure as described herein, embodiments of the present disclosure provide an improved, more user-friendly adapter assembly 100 configured to enable coupling and decoupling of a ruggedized connector 50 with a single hand (as opposed to two hands), which can be particularly beneficial in cramped or hard-to-reach installations, or elevated installations where for safety reasons the user may be required to keep one hand on a ladder or other supporting surface.

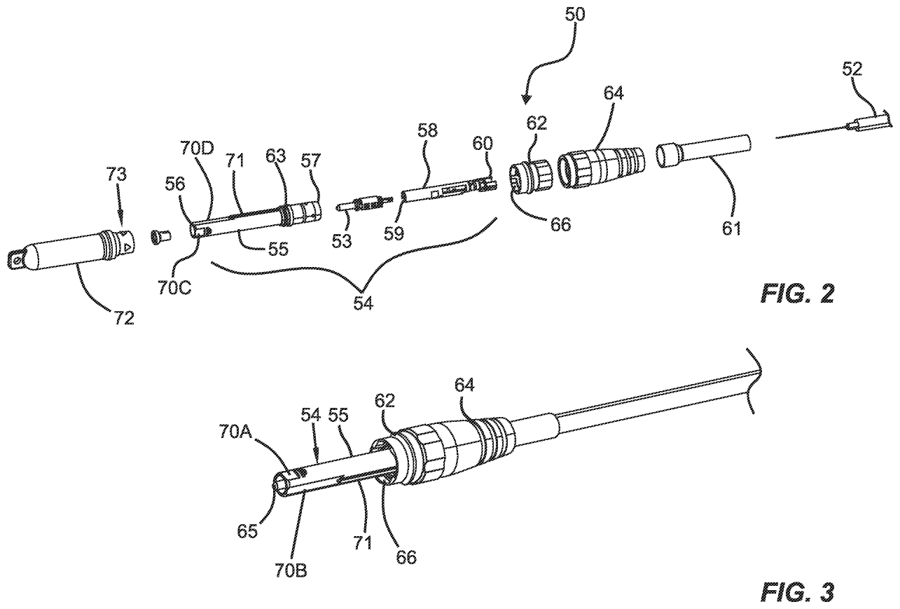

Referring to FIGS. 2-3, a ruggedized connector 50 is depicted in accordance with an embodiment of the disclosure. It will be appreciated that the ruggedized connector 50 serves to provide a mounting structure for a pre-terminated fiber-optic cable 52, thereby providing structure at a terminal end of the fiber-optic cable 52 for optical connection by a selectively mateable optical connection. For example, the fiber-optic cable 52 can be pre-terminated by mounting a ferrule 53 at a terminal end of the fiber-optic cable 52 in preparation for presenting the fiber-optic cable as part of a ferruled optical connector. In other embodiments, a housing or other structure can be attached to the fiber-optic cable 52 to align or position the fiber-optic cable 52 without the use of a ferrule, as in the case of a ferrule-less optical connector.

In the depicted embodiment, the fiber-optic cable 52 is “pre-terminated” by mounting a connector core 54 at a terminal end of the fiber-optic cable 52 prior to assembling one or more environmentally resistant, ruggedized arrangements over the connector core 54. With continued reference to FIG. 2, the connector core 54 can include a housing 55 extending along a longitudinal axis of the ruggedized connector 50. The housing 55 can include a distal plug end 56 positioned opposite from a proximal cable attachment end 57.

The fiber-optic cable 52 is attached or secured to the connector core 54 at the proximal cable attachment and 57 of the housing 55. An inner body 58 mounts within the connector core 54 and includes a front end 59 that functions as a spring stop and a rear end 60 that can include structure for use in securing strength members of the fiber-optic cable 52 to the connector core 54, thereby enabling one or more strength members at least partially surrounding the fiber-optic cable 52 (e.g., aramid yarn, fiberglass fibers, or the like) to be attached to the connector core 54 at the proximal cable attachment and 57 by crimping, adhesive or the like.

An outer jacket of the fiber-optic cable 52 can be secured to the proximal cable attachment end 57 of the connector core 54 by a sleeve 61, such as a shape memory sleeve (e.g., heat shrink sleeve). In some embodiments, the sleeve 61 can include an inner layer of adhesive for bonding the sleeve 61 to both the outer jacket of the fiber-optic cable 52 and the housing 55.

A turn to secure fastener 62 is mounted over the connector core 54 and can be turned (e.g., rotated) relative to the connector core 54 about the longitudinal axis. The turn to secure fastener 62 is captured axially between an outer stop 63 (e.g., shoulder) of the housing 55 and the sleeve 61, such that the turn to secure fastener 62 is retained on the housing 55. In some embodiments, a strain relief boot 64 at least partially surrounds the sleeve 61 can be turned in unison with the turn to secure fastener 62 about the longitudinal axis of the ruggedized connector 50

In some embodiments, the fiber-optic cable 52 includes a first section routed longitudinally through the outer jacket of the fiber-optic cable 52, and a second section routed through the connector core 54. The second section of the fiber-optic cable 52 can define a fiber tip 65 which can protrude from the distal plug end 56 when assembled. Specifically, the fiber tip 65 can be secured and supported by the ferrule 53, which can be spring biased in a forward direction relative to the housing 55 by a spring.

In the case where the ferrule 53 is directly mounted on a terminal end of the fiber-optic cable 52, the fiber-optic cable 52 can be configured as an uninterrupted length of optical fiber where the first and second sections form a single continuous structure. In a splice on version of the connector arrangement, the second section can be optically spliced (e.g., fusion spliced, etc.) to the first section of the fiber-optic cable 52. In some embodiments, the optical splice can be located within an interior of the inner body 58.

The turn to secure fastener 62 can include a coupling arrangement 66 adapted to mate or otherwise couple with a corresponding coupling arrangement provided on components adapted to be coupled to the ruggedized connector 50 (e.g., adapter assembly 100, etc.). For example, in some embodiments, the coupling arrangement 66 can define structure enabling two different interlock functions. In other embodiments, the coupling arrangement 66 can be of a threaded, bayonet style, snap fit, or other interlock configuration having one or more stops that are selectively rotated from a non-overlapping position to an overlapping position with a corresponding coupling arrangement provided on a second component to be mated with the ruggedized connector 50, thereby providing an interlocking between the coupling arrangements of the ruggedized connector 50 and the adapter assembly 100 or other component (the coupling arrangements collectively referred to as a coupling interface) to establish axial retention of the ruggedized connector 50 relative to the adapter assembly 100 along a longitudinal axis of the ruggedized connector 50 and adapter assembly 100.

In some embodiments, the coupling arrangement 66 can define two distinct interlock functions, including a first interlock function and a second interlock function. The first interlock function can be adapted to inhibit rotation between the turn to secure fastener 62 and the corresponding coupling arrangement of the adapter assembly 100. The second interlock function can be adapted to establish axial retention between the ruggedized connector 50 and the adapter assembly 100.

The first interlock function can be provided by a snap fit arrangement, configured to provide at least one of permanent or multi-use interlock functionality. In the case of a permanent interlock, a snap fit connection between the coupling arrangements is required to be broken to rotate the turn to secure fastener 62 from an interlocked position to a non-interlocked position. In contrast, if the snap fit arrangement is adapted for multiple uses, the snap fit arrangement can function as a detent that encourages the turn to secure fastener 62 to remain in an interlocked position, but with a sufficient amount of torque applied enables the snap fit arrangement to be disengaged without breaking the snap fit arrangement to enable the secure fastener 62 to rotate from the interlocked position to the non-interlocked position.

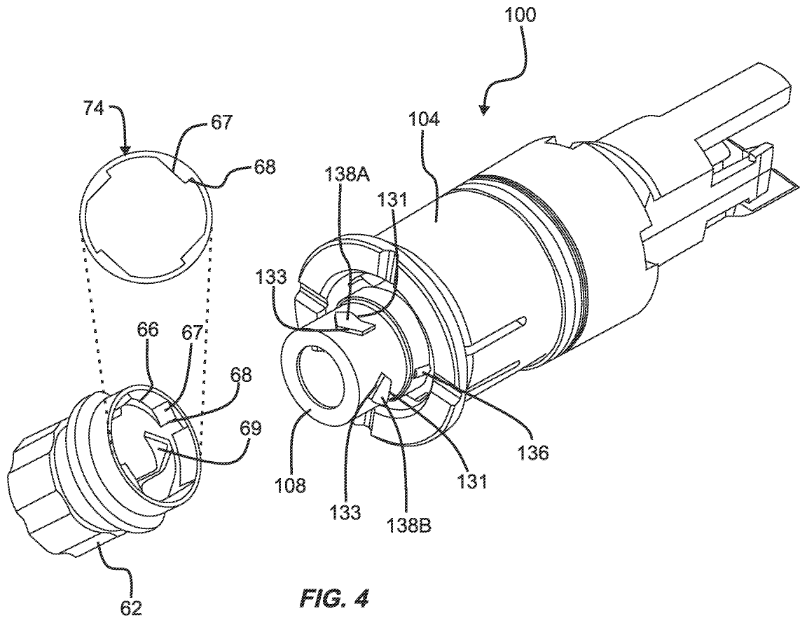

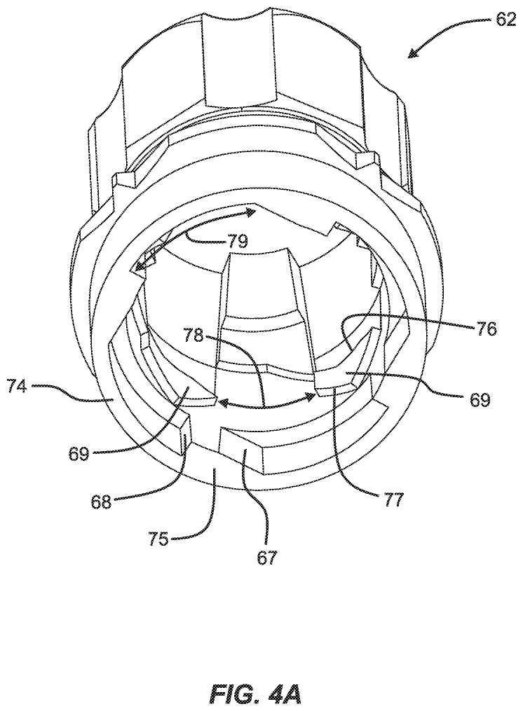

With additional reference to FIGS. 4 and 4A, in some embodiments, the coupling arrangement 66 of fastener 62 can include at least one ramp surface 67 and at least one stop surface 68. For example, in some embodiments, the coupling arrangement 66 can include a plurality of ramp surfaces 67 and stop surfaces 68 spaced about the longitudinal axis of the ruggedized connector 50 along a radial surface of an interior wall of the fastener 62. As further depicted, an orthogonal profile of the ramp surfaces 67 and the stop surfaces 68 (e.g., orthogonal to the radial surface of the interior wall of the fastener 62) can be present on a distal end 74 of the fastener 62, such that an end profile of the ramp surfaces 67 and stop surfaces 68 form a distal end 74 having a profile forming one or more push surfaces 75 configured to interact with corresponding surfaces of the retention collar 104.

In some embodiments, the profile of the distal end 74 can interact with the retention collar 104 of the adapter assembly 100. For example, abutting interference between one or more push surfaces 75 of the distal end 74 and portions of the retention collar 104 can serve to shift the retention collar 104 from the extended position to the retracted position, when the fastener 62 is inserted into the adapter assembly 100, particularly while the ruggedized connector 50 is in the initial, non-interlocked position.

As further described below, as a portion of the connector 50 (e.g., the fastener 62 and/or strain relief boot 64) is rotated to the interlock position, the one or more push surfaces 75 rotate out of abutting contact with corresponding surfaces of the retention collar 104, thereby enabling the retention collar to shift from the retracted position back to the extended position. In some embodiments, at least one ramp surface 67 and stop surface 68 can simultaneously ride over a snap fit feature 136 defined by the adapter assembly 100, such that back rotation of the fastener 62 is inhibited by abutment between the stop surface 68 and the snap fit feature 136, thereby completing the first interlock function to inhibit inadvertent back rotation of the fastener 62 relative to the adapter assembly 100 from the interlocked position to the non-interlocked position.

The second interlock function, which in some embodiments can operate simultaneously with the first interlock function, relates to providing axial securement of the fastener 62 relative to a coupling interface of the adapter assembly 100 or other component. The structure of the second interlock function that provides the axial retention can include one or more projections 69 that extend radially inward from a radial surface of an interior wall of the fastener 62 to define one or more corresponding stop surfaces 76 configured to engage with one or more stops 138 of the adapter assembly 100.

In some embodiments, the one or more projection 69 can further define one or more ramp surfaces 77 configured to initially align the one or more stops 138 of the adapter assembly 100 to pass through a gap 78 defined between adjacent projections 69. In some embodiments, the initial alignment enabling the one or more stops of the adapter assembly 100 pass through the gap 78 can additionally align the push surfaces 75 of the fastener 62 with the corresponding surfaces of the retention collar 104, such that further axial movement of the fastener 62 relative to the adapter assembly 100 causes the retention collar 104 to shift from the extended position to the retracted position.

As the fastener 62 is rotated to the interlock position, in addition to removal of abutting contact between the push surfaces 75 of the faster with the corresponding surfaces of the retention collar 104, and performance of the first interlock function as described above, the fastener 62 is rotated such that the stop surfaces 76 of the projections 69 are brought into abutting contact with corresponding stop surfaces 131 of the stops 138, thereby inhibiting the fastener 62 from being axially removed from the adapter assembly 100 or other corresponding component to which the fastener 62 is coupled.

With continued reference to FIGS. 2-3, the distal plug end 56 can optionally have a form factor compatible with at least one of SC or LC type fiber-optic adapters, although other form factors are also contemplated. For example, in some embodiments, the connector core 54 can define a plurality of flats 70A-D, positioned about an exterior of the housing 55. For example, flats 70A and 70C can be positioned opposite from one another, while flats 70B and 70D can be positioned opposite from one another. In some embodiments, flats 70B and 70D can extend rearwardly from the distal plug end 56 for a substantial length of the housing 55, while flats 70A and 70C can be substantially shorter in length. In some embodiments, flats 70B and 70D can extend from the distal plug end 56 to one or more keyed projections 71, which can be axially aligned with the longitudinal axis of the ruggedized connector 50. In some embodiments, the one or more keyed projections, which can serve to rotationally align the ruggedized connector 50 with the adapter assembly 100 or other component, can extend along at least 25% of a total length of the housing 55.

In some embodiments, the ruggedized connector 50 can further include a dust cap 72 configured to be selectively secured to the ruggedized connector 50 for the purpose of protecting the connector core 54. For example, in some embodiments, the dust cap can include a coupling arrangement 73 configured to mate with coupling arrangement 66. It will be appreciated that the dust cap 72 is required to be removed from the connector core 54 prior to coupling the connector core with any of its mating components.

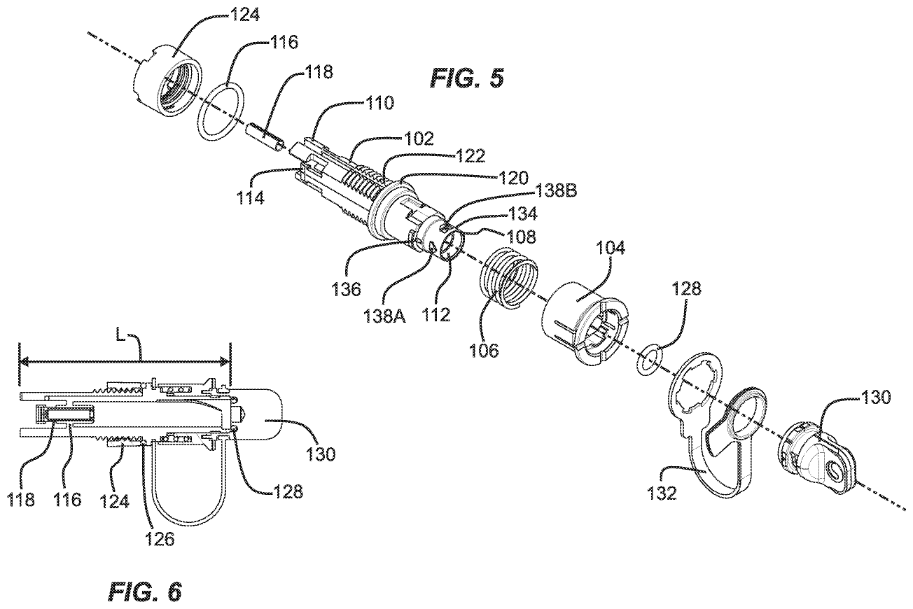

Referring to FIGS. 5-6, an adapter assembly 100 is depicted in accordance with an embodiment of the disclosure. It will be appreciated that mating of the adapter assembly 100 with the ruggedized connector 50 can be accomplished with a single hand, while still guarding against inadvertent back rotation of the ruggedized connector 50 from the interlocked position to the non-interlocked position with the use of a shiftable retention collar 104, which is configured to automatically shift from an extended position to a retracted position against the bias of a spring 106 when the ruggedized connector 50 is inserted into the adapter assembly 100. Additionally, the adapter assembly 100 is configured to provide separation of the ruggedized connector 50 from the adapter assembly 100 with a single hand, as a user can manually shift the retention collar 104 from the extended position to the retracted position against the natural bias of the spring 106 with the same hand used to rotate the ruggedized connector 50 from the interlocked position back to the non-interlocked position, thereby enabling decoupling of the ruggedized connector 50 from the adapter assembly 100.

In embodiments, the adapter assembly 100 is configured to mount within a mounting opening defined in a panel or other mounting structure (e.g., through the wall of an enclosure). In some embodiments, the mounting opening can have an area of less than or equal to about 185 mm², less than or equal to about 165 mm², or less than or equal to about 150 mm². Other sizes of the mounting opening are also contemplated. It will be appreciated that the adapter assembly 100 can have a length (L) that is relatively long in comparison to the mounting opening. For example, in some embodiments, a ratio of the area of the mounting opening in millimeters to the length (L) of the adapter assembly is less than or equal to about three.

With continued reference to FIG. 5, the adapter assembly 100 can include a main adapter body 102, having a first end 108 and a second end 110, wherein a length (L) of the adapter assembly 100 extends between the first and second ends 108, 110. In some embodiments, the first end 108 defines a ruggedized connector port 112 (e.g., connectable to the ruggedized connector 50) and can be referred to as the ruggedized end. In embodiments, the main adapter body 102 can be of a unitary (e.g., single piece, monolithically formed, etc.), molded construction, which can have a form factor that matches or is otherwise compatible with the form factor of the connector core 54 of the ruggedized connector 50. The second end 110 defines a non-ruggedized connector port 114 (e.g., connectable to a non-ruggedized connector 51) and can be referred to as the non-ruggedized end. In embodiments, the non-ruggedized end can be adapted to receive a non-ruggedized connector 51 (e.g., SC or LC type fiber-optic connector or the like).

With reference to FIG. 6, in some embodiments, the main adapter body 102 can include an internal sleeve holder 116 configured to house a ferrule alignment sleeve, such as a split sleeve 118 made of an elastic material (e.g., phosphor bronze, zirconia ceramic, etc.). In some embodiments, the internal sleeve holder 116 can include a plurality of fingers that can be flexed open to enable the split sleeve 118 to be inserted within and retained inside the internal sleeve holder 116.

When the non-ruggedized connector 51 is secured to the non-ruggedized connector port 114, and the ruggedized connector 50 is secured to the ruggedized connector port 112, the non-ruggedized connector 51 and the ruggedized connector 50 are optically connected together, such that the ruggedized and non-ruggedized fiber-optic connectors 50, 51 are coaxially aligned to provide an optical connection between the optical fibers contained within each of the ruggedized and non-ruggedized connectors 50, 51.

The main adapter body 102 can define an outer flange 120 and exterior threads 122. When the main adapter body 102 is secured within the mounting opening defined through a panel or wall, the outer flange 120 engages a first side of the panel, while a nut 124 is threaded onto the exterior threads 122 to engage a second side of the panel. In this way, the panel is compressed between the outer flange 120 and the nut 124 to secure the main adapter body 102 to the panel. In some embodiments, the adapter assembly 100 can further include a gasket or other seal 126 (e.g., configured to abut up against the flange 120) when secured within a mounting opening to inhibit water and dirt intrusion through the mounting opening. An additional seal 128 positioned in proximity to the ruggedized connector port 112 can further inhibit water and dirt intrusion into the ruggedized end of the adapter assembly 100.

In some embodiments, the adapter assembly can include a dust cap 130, which can optionally be tethered to the main adapter body 102 via a lanyard 132. In embodiments, the dust cap 130 can be adapted to be secured over the ruggedized connector port 112 prior to inserting the connector core 54 of the ruggedized connector 50 therein. It will be appreciated that the dust cap 130 can be removed from the first end 108 of the main body adapter 102 to allow insertion of the connector core 54 into the ruggedized connector port 112. It will also be appreciated that the dust cap 130 can include an internal coupling arrangement of the type shown and described in connection with the coupling arrangement 66 of the ruggedized connector 50 that is adapted to couple with the coupling arrangement 134 provided adjacent to the first end 108 of the main adapter body 102.

The coupling arrangement 134 can include two distinct interlock functions configured to interlock with the coupling arrangement 66 of the connector 50, including a first interlock function adapted to inhibit rotation between the adapter assembly 100 and the connector 50, and a second interlock function configured to establish axial retention between the adapter assembly 100 and a connector 50.

As part of the first interlock function, the coupling arrangement 134 can include one or more snap fit features 136 adapted to engage the ramp surface 67 and stop surface 68 of coupling arrangement 66 to retain the coupling arrangements 66, 134 in the interlocked position (e.g., to inhibit back rotation of the ruggedized connector 50 from the interlocked position to the non-interlocked position). As depicted in FIG. 4, in one embodiment, the snap fit feature 136 can be in the form of a protruding ridge, bump or other detent over which the ramp surface 67 and the stop surface 68 of the coupling arrangement 66 ride as the turn to secure fastener 62 is rotated relative to the coupling arrangement 134 from the non-interlocked position to the interlocked position.

In some embodiments, the snap fit feature 136 includes angled surfaces on both sides, thereby enabling the snap fit feature 136 to be rotated from the non-interlocked position to the interlocked position, and back to the non-interlocked position when sufficient torque is applied to force the snap fit feature 136 back over the stop surface 68. Adjustment of the angles of the ramp surface 67, stop surface 68 and snap fit feature 136 can provide the desired degree of torque to rotate the turn to secure fastener 62 between the non-interlocked and interlocked positions. For example, in embodiments, the ramp surface 67 has a shallower pitch than the stop surface 68, thereby enabling the snap fit feature 136 to ride over the ramp surface 67 one moving from the non-interlocked position to the interlocked position with a lesser amount of torque than required when riding over the stop surface 68 in the opposite direction (e.g., from the interlocked position back to the non-interlocked position). Accordingly, the snap fit feature 136 (and corresponding ramp surface 67 and stop surface 68) cooperate to maintain the turn to secure fastener 62 in the interlocked position.

As part of the second interlock function, the coupling arrangement 134 can include one or more stops 138A/B (e.g., triangular projections, etc.), which can be spaced about an exterior circumference of the main adapter body 102 in proximity to the first end 108. In embodiments, the one or more stops 138A/B of the coupling arrangement 134 (including stop surfaces 131) can interlock with and oppose the stop surfaces 76 of coupling arrangement 66, such that the interference between the stop surfaces 131 and 76 inhibit the turn to secure fastener 62 from being axially disengaged from the coupling arrangement 134. Further, the surfaces of the one or more stops 138A/B serve to force the connector core 54 of the ruggedized fiber-optic cable into abutting contact with the non-ruggedized fiber-optic cable, thereby ensuring that the ferrule 53 is properly seated within the adapter assembly 100. It will be appreciated that a number of different shapes and configurations of stops 138 are contemplated, including those disclosed in International Publication Nos. WO2020/236512 and WO2021/041305, the contents of which are incorporated by reference to the extent that they do not conflict with the teachings herein.

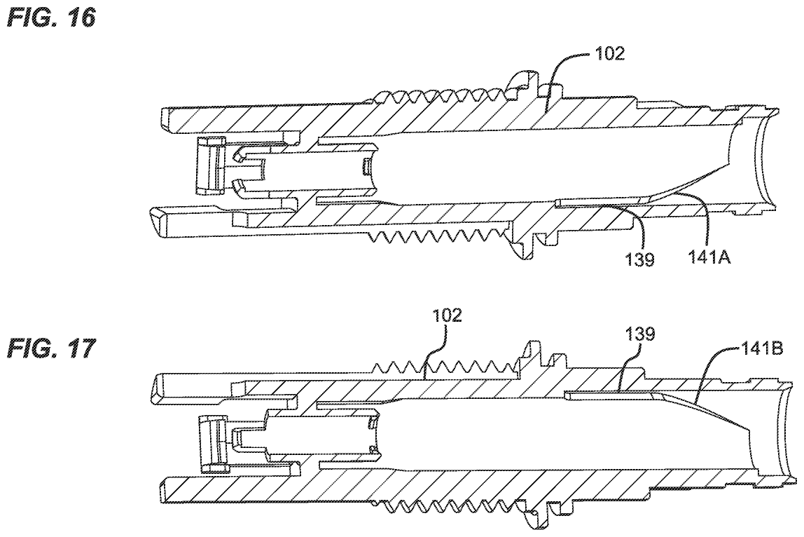

With additional reference to FIGS. 16-17, as an aid in alignment of the ruggedized connector 50 relative to the adapter assembly 100, in some embodiments, an interior wall of the main adapter body 102 can define a keyway 139 for receiving the keyed projection 71 of the ruggedized connector 50. In some embodiments, the keyway 139 can include a pair of helical shoulders 141A/B that rotate in opposite helical directions about a central longitudinal axis of the main adapter body 102. In some embodiments, the helical shoulders 141A/B can provide for rotational guiding of the ruggedized connector 50 as the ruggedized connector 50 is inserted into the adapter assembly 100 along a rotational range of movement of at least about 180°, 170°, 135°, 90°, 45°, or 30° thereby aiding in an initial alignment of the coupling arrangement 66 of the ruggedized connector 50 with the coupling arrangement 134 of the fiber-optic connector adapter assembly 100.

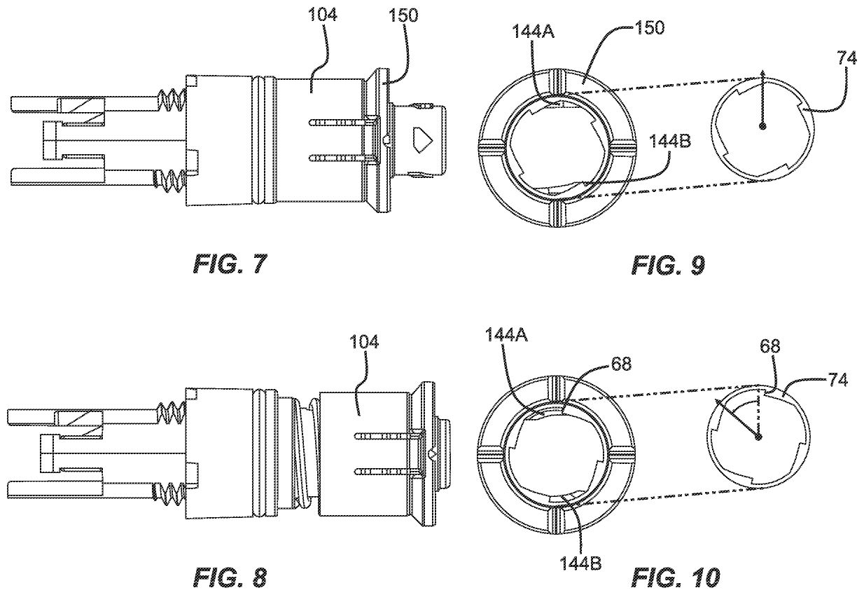

As an additional securement element to inhibit inadvertent separation of the ruggedized fiber-optic cable from the adapter assembly 100, the adapter assembly 100 can include a retention collar 104, which can be axially shiftable relative to the main adapter body 102 between an extended position (as depicted in FIG. 8) and a retracted position (as depicted FIG. 7) along a longitudinal axis of the adapter assembly 100, wherein the retention collar 104 is biased via a biasing element, for example via a coil spring 106, to the extended position. In this way, the retention collar 104 can automatically move from the retracted position to the extended position once the turn to secure faster 62 transitions from the non-interlocked position to the interlocked position.

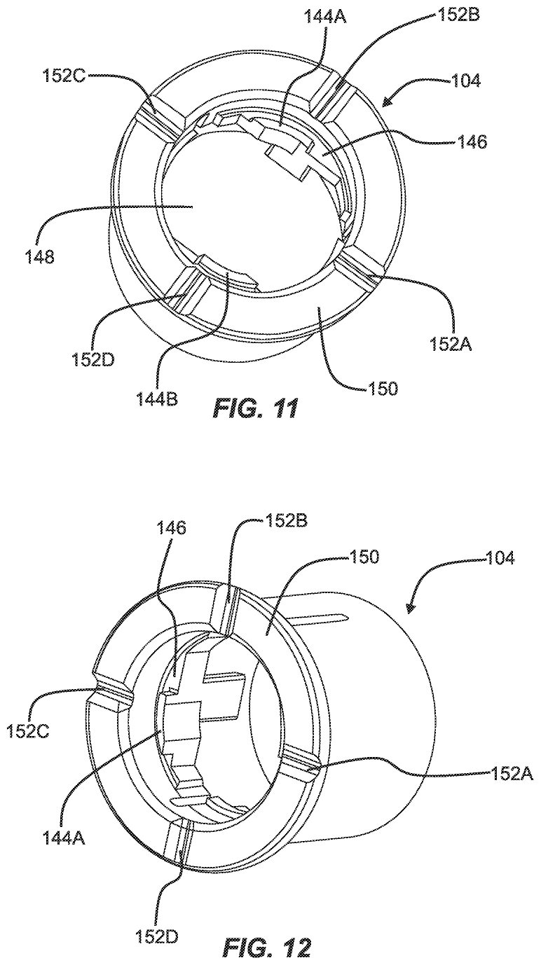

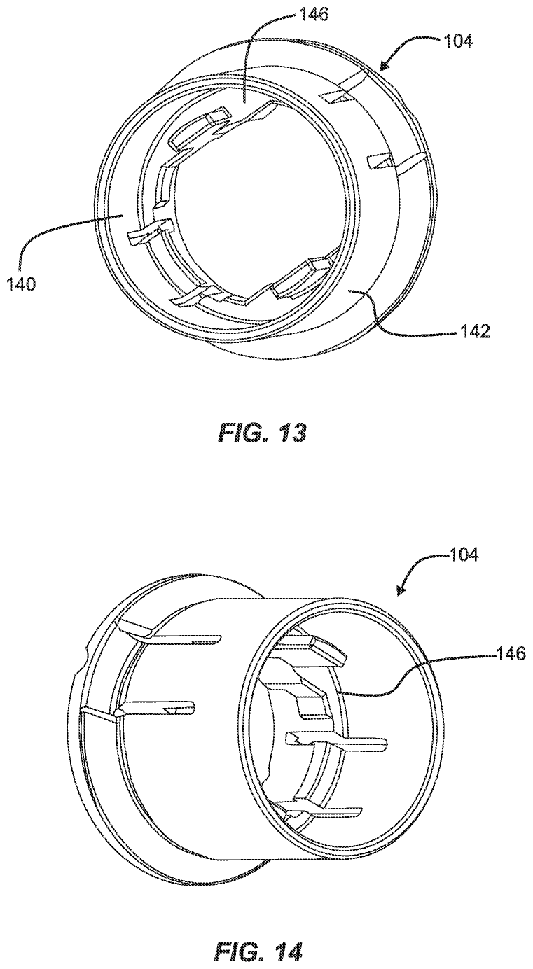

With additional reference to FIGS. 11-14, in embodiments, the retention collar 104 can be generally configured as a cylindrical tube defining an interior wall 140 and an exterior wall 142. The interior wall 140 can define one or more shoulders 144A/B configured to interact with the one or more push surfaces 75 of the fastener 62 to shift the retention collar 104 from the extended position to the retracted position. For example, the one or more shoulders 144A/B can define shaped or keyed protrusions formed to interact with the one or more push surfaces 75 of the distal end 74 of the fastener 62. In some embodiments, the one or more shoulders 144A/B can extend distally from a ridge 146 traversing at least partially around the interior wall 140, substantially orthogonal to a longitudinal axis of the retention collar 104. For example, in some embodiments, the one or more shoulders 144A/B can be configured as an arc shaped protrusion having a shape and size configured to fit within a gap 79 defined between adjacent push surfaces 75 of the fastener 62. In some embodiments, the ridge 146 can define an opening 148 (e.g., similar to the shape of the mounting opening) into which a portion of the main adapter body 102 can be positioned.

With reference to FIGS. 9-10, the one or more shoulders 144A/B can interact with the distal end 74 of the ruggedized connector 50 during the process of mating the ruggedized connector 50 to the adapter assembly 100. For example, abutting interference between the distal end 74 and the one or more shoulders 144A/B of the retention collar 104 can serve to shift the retention collar 104 from an initial extended position to the retracted position (as depicted in FIG. 7), when the fastener 62 is inserted into the adapter assembly 100, particularly while the ruggedized connector 50 is in the non-interlocked position (as depicted in FIG. 9).

In some embodiments, one or more ramp surfaces 77 defined by one or more projections 69 positioned on an interior wall of the fastener 62 can be configured to interact with ramp surfaces 133 of the stops 138 to initially align the one or more stops 138 of the adapter assembly 100 to pass through a gap 78 defined between adjacent projections 69, such that the initial alignment between the adapter assembly 100 and fastener 62 serves to align the push surfaces of the fastener 62 with the corresponding shoulders 144 of the adapter assembly 100, as well as to enable the one or more stops 138 to pass through the gaps 78 defined between adjacent projections 69.

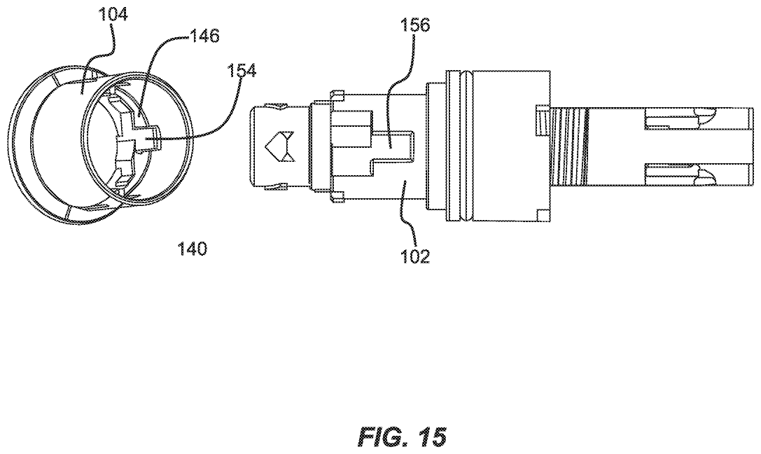

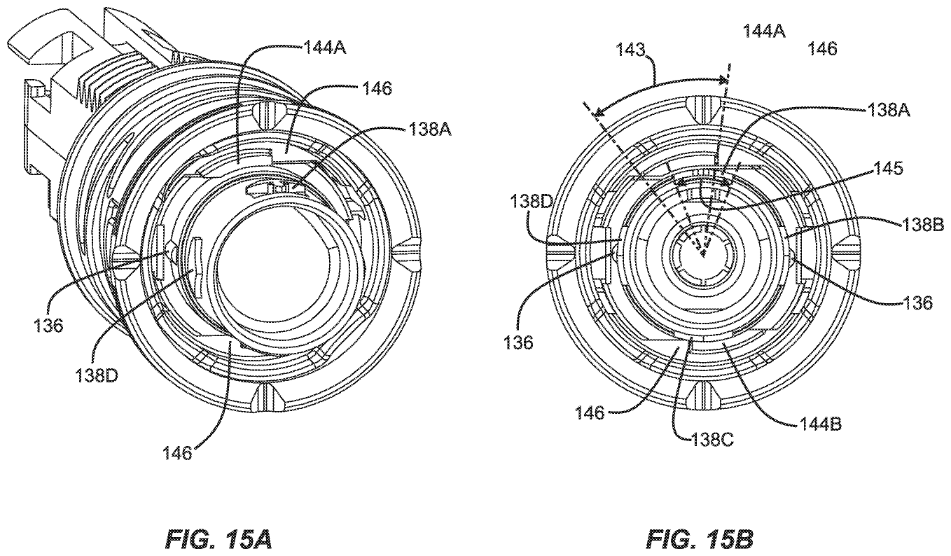

With additional reference to FIGS. 15A and 15B, to facilitate such an alignment, in some embodiments, at least one of the one or more shoulders 144 can be radially aligned with at least one of the one or more stops 138. For example, in some embodiments, each of the one or more shoulders 144 can span a first radial angle 143, which in some embodiments can be an angle of between about 15° and about 45°, or between about 15° and about 30°, between about 5° and about 15°, etc. In some embodiments, each of the one or more stops 138 can span a second radial angle 145, which in some embodiments can be an angle of between about 5° and about 30°, or less than about 30°, or less than about 15°, etc. In some embodiments, the first radial angle 143 can at least partially overlap with the second radial angle 145, thereby enabling an interaction between the stops 138 and ramp surfaces 77 of projections 69 to align the push surfaces 75 of the fastener 62 into abutting contact with the shoulders 144.

As the ruggedized connector 50 is rotated to the interlock position (as depicted in FIG. 10), the one or more shoulders 144A/B of the retention collar 104 cooperate with the one or more push surfaces 75, thereby enabling the retention collar 104 to shift from the retracted position to the extended position (as depicted in FIG. 8). For example, in some embodiments, rotation of the ruggedized connector 50 relative to the adapter assembly 100 can take place over an angle of about 30°, 45°, 90°, 135°, etc. Thereafter, the distal end 74 at least partially rests on the ridge 146, with the one or more shoulders 144A/B opposing the stop surfaces 68, thereby inhibiting inadvertent back rotation of the ruggedized connector 50 from the interlocked position to the non-interlocked position.

In some embodiments, at least one ramp surface 67 and stop surface 68 can simultaneously ride over the snap fit feature 136 defined by the adapter assembly 100, such that back rotation of the fastener 62 relative to the adapter assembly 100 is inhibited by abutment between the stop surface 68 and the snap fit feature 136, thereby completing the first interlock function to inhibit inadvertent back rotation of the fastener 62 relative to the adapter assembly 100 from the interlocked position to the non-interlocked position. As depicted in FIGS. 15A and 15B, in some embodiments, a radial position of the snap fit feature 136 can be offset from a position of the shoulders 144. For example, in one embodiment, the radial position of the snap fit feature 136 can be about 90° offset from a radial position of the shoulder 144; although other positions of the snap fit feature 136 are also contemplated.

The second interlock function, which in some embodiments can operate simultaneously with the first interlock function, relates to providing axial securement of the fastener 62 relative to the adapter assembly 100, through an interaction between one or more stop surfaces 76 defined by the fastener 62 and one or more corresponding stop surfaces 131 defined by the stops 138 of the adapter assembly 100. Accordingly, as the fastener 62 is rotated to the interlock position, in addition to removal of abutting contact between the push surfaces 75 of the fastener 62 with the corresponding shoulders 144 of the collar 104, and performance of the first interlock function, the fastener 62 is rotated such that the stop surfaces 76 of the projection 69 are brought into abutting contact with the stop surfaces 131 of the stops 138, thereby inhibiting the fastener 62 from being actually removed from the adapter assembly 100.

Thereafter, if it is desired to decouple the ruggedized connector 50 from the adapter assembly 100, the retention collar 104 must be manually shifted from the extended position back to the retracted position, thereby shifting the one or more shoulders 144A/B out of interfering contact with the stop surfaces 68 of the distal end 74. Thereafter, the ruggedized connector 50 can be rotated from the interlocked position to the non-interlocked position (e.g., against the resistance of the first interlock function), thereby enabling removal of the ruggedized connector 50 from the adapter assembly 100.

To aid in shifting the retention collar 104 from the extended position to the retracted position, in some embodiments, the retention collar 104 can define a flange 150, which can be positioned circumferentially around a distal end of the retention collar 104. In particular, in some embodiments, the flange 150 can extend radially outward from an exterior wall of the retention collar 104, so as to establish a larger surface area for manipulation of the retention collar 104. To further aid in manipulation of the retention collar, in some embodiments, the flange 150 can define a plurality of flats or grooves 152A-D spaced around a perimeter of the flange 150 (as depicted in FIG. 11-12), which in some embodiments can aid a user in gripping the retention collar 104. For example, in some embodiments, the flange 150 can define four grooves 152A-D, although a greater or fewer number of grooves or flats are also contemplated.

In practice, the grooves 152A-D can enable a user to use a tool (e.g., flat-head screwdriver or the like) to move the retention collar from the extended position to the retracted position for removal of the ruggedized connector 50 from the adapter assembly 100, particularly where the retention collar 104 may be positioned in a crowded environment where finger clearance may be an issue. In such cases, a user can grip and rotate the strain relief boot 64 of the ruggedized connector 50, which can turn in unison with the fastener 62 of the ruggedized connector 50, thereby releasing the ruggedized connector 50 from the adapter assembly 100.

In some embodiments, the retention collar 104 is non-rotatably mounted relative to the main adapter body 102, such that the retention collar 104 cannot be rotated about the central axis of the adapter assembly 100. For example, as best depicted in FIG. 15, in some embodiments, one or more anti-rotation tabs 154 can extend proximally from the ridge 146 defined by the interior wall 140 of the retention collar 104. The one or more anti-rotation tabs 154 can be configured to shift, translate or slide within one or more channels 156 defined by the main adapter body 102, such that rotation of the retention collar 104 relative to the main adapter body 102 is inhibited.

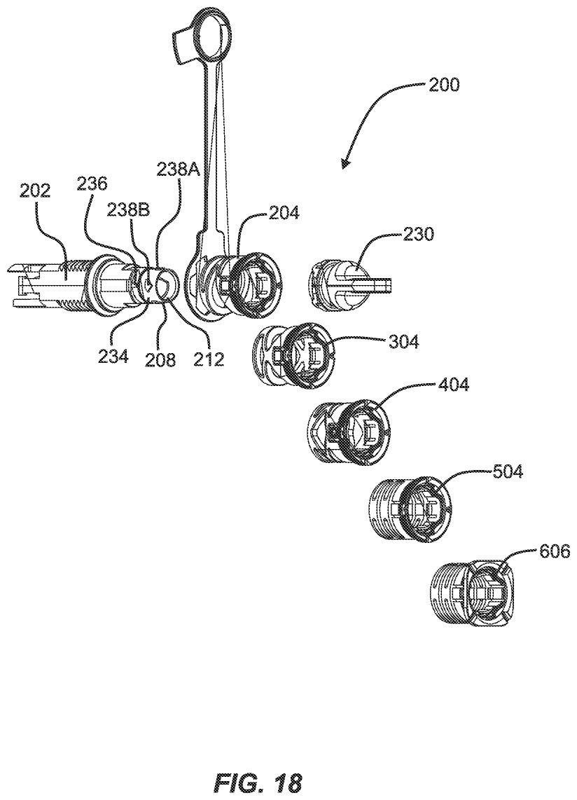

Referring to FIG. 18, an adapter assembly 200 is depicted in accordance with an alternative embodiment of the disclosure. It will be appreciated that mating of the adapter assembly 200 with the ruggedized connector 50 can be accomplished with a single hand, while guarding against inadvertent back rotation of the ruggedized connector 50 from the interlocked position to the non-interlocked position with the use of a shiftable retention spring collar 204, which is configured to automatically shift from an extended position to a retracted position under its own bias when the ruggedized connector 50 is inserted into the adapter assembly 100. That is, in some embodiments, the retention collar and spring, as described in the previous embodiments can be combined to form a retention spring collar 204, in which the spring is integrated into the retention collar to form a unitary, monolithically formed, single piece retention spring collar 204 that has a natural spring bias, thereby enabling the retention spring collar 204 to shift between a relaxed or extended position and a compressed or retracted position.

Additionally, the adapter assembly 200 is configured to provide separation of the ruggedized connector 50 from the adapter assembly 100 with a single hand, as the user can manually shift the retention spring collar 204 from the extended position to the retracted position against the natural bias of the retention spring collar 200 itself with the same hand used to rotate the ruggedized connector 50 from the interlock position back to the non-interlocked position, thereby decoupling the ruggedized connector 50 from the adapter assembly 200.

Like the previous embodiment, the adapter assembly 200 can include a main adapter body 202, having a first end 208 and a second end 210, wherein a length of the adapter assembly 200 extends between the first and second ends 208, 210. In some embodiments, the first end 208 defines a ruggedized connector port 212 (e.g., connectable to the ruggedized connector 50) and can be referred to as the ruggedized end. The second and 210 defines a non-ruggedized connector port 214 (e.g., connectable to a non-ruggedized connector 51) and can be referred to as the ruggedized end. When the non-ruggedized connector 51 is secured to the non-ruggedized connector port 214, and the ruggedized connector 50 is secured to the ruggedized connector port 212, the non-ruggedized connector 51 and the ruggedized connector 50 are optically connected together, such that the ruggedized and non-ruggedized fiber optic connectors 50, 51 are coaxially aligned to provide an optical connection between the optical fibers contained within each of the ruggedized and non-ruggedized connectors 50, 51.

In some embodiments, the adapter assembly 200 can include a dust cap 230, which can optionally be tethered to the main body adapter 202 via a lanyard 232. In embodiments, the dust cap 230 can be adapted to be secured over the ruggedized connector port 212 prior to inserting the connector core of the ruggedized connector 50 therein. It will be appreciated that the dust cap 130 can be removed from the first end 208 of the main body adapter 202 to allow insertion of the connector core into the ruggedized connector port 212. It will also be appreciated that the dust cap 230 can include an internal coupling arrangement of the type shown and described in connection with the coupling arrangement 66 of the ruggedized connector 50 that is adapted to couple with a coupling arrangement 234 provided adjacent to the first end 208 of the main adapter body 202.

The coupling arrangement 234 can include two distinct interlock functions, including a first interlock function adapted to inhibit rotation between the coupling arrangement 234 and the corresponding coupling arrangement (e.g., the coupling arrangement 66 of the ruggedized connector 50), and a second interlock function configured to establish axial retention between the coupling arrangement 234 and the corresponding coupling arrangement (e.g., the coupling arrangement 66 of the ruggedized connector 50).

As part of the first interlock function, the coupling arrangement 234 can include one or more snap fit features 236 configured to engage the ramp surface 66 and stop surface 68 of the coupling arrangement 66 to retain the coupling arrangements 66, 234 in the interlock position (e.g., to inhibit back rotation of the ruggedized connector 50 from the interlock position to the non-interlocked position).

As part of the second interlock function, the coupling arrangement 234 can include one or more stops 238A/B (e.g., triangular projections, etc.) which can be spaced about an exterior circumference of the main adapter body 202 in proximity to the first end 208. In embodiments, the one or more stops 238A/B of the coupling arrangement 234 can interlock with and oppose stops 69 of the coupling arrangement 66, such that the interference between the stops 238A/B and 69 inhibit the turn to secure fasteners 62 from being axially disengaged from the coupling arrangement 234.

As an additional securement element to inhibit inadvertent separation of the ruggedized fiber-optic cable from the adapter assembly 200, the adapter assembly 200 can include a retention spring collar 204, 304, 404, 504, 604, which can be actually shiftable relative to the main adapter body 202 between an extended position (as depicted in FIG. 18) and a retracted position along a longitudinal axis of the adapter assembly 200, wherein the retention spring collar 204, 304, 404, 504, 604 is naturally biased via an integrated biasing element to the extended position. In this way, the retention spring collar 204, 304, 404, 504, 604 can automatically move from the retracted position to the extended position once the turn to secure fastener 62 transitions from the non-interlock position to the interlock position. As further depicted in FIG. 18, various embodiments of the retention spring collar 204, 304, 404, 504, 604 are contemplated.

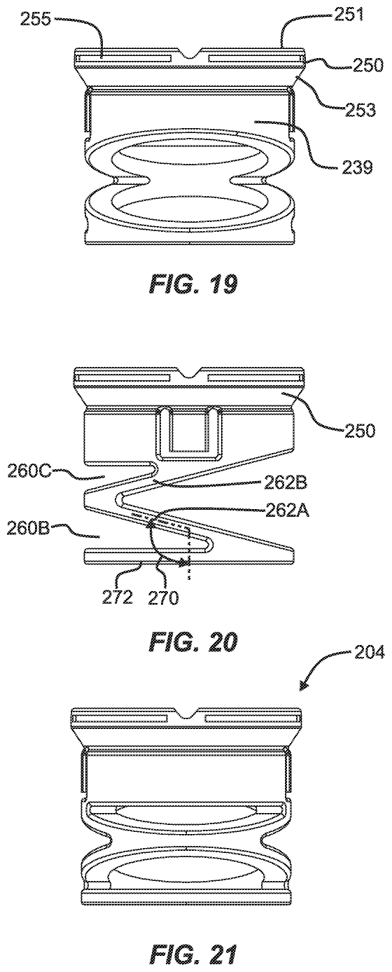

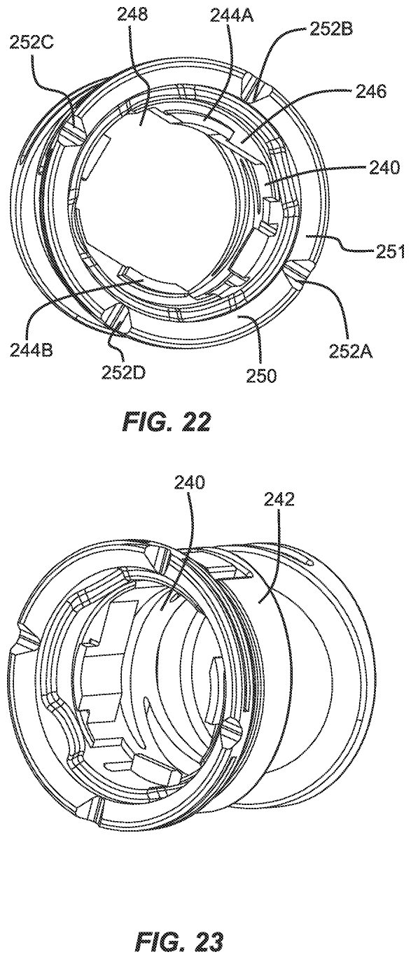

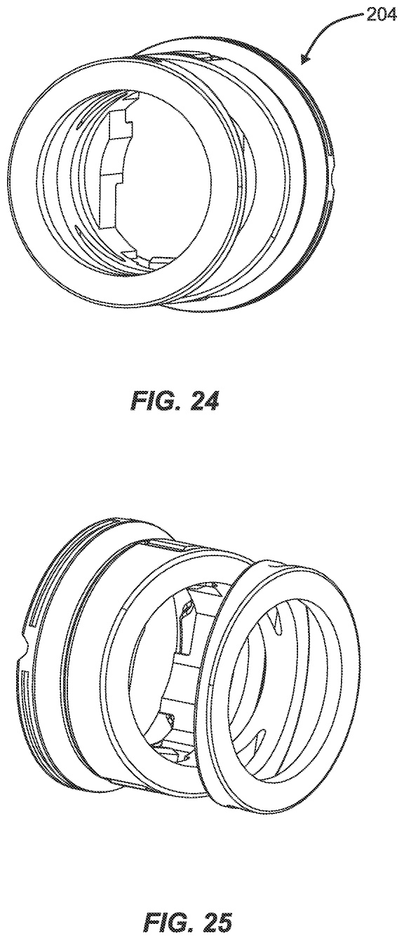

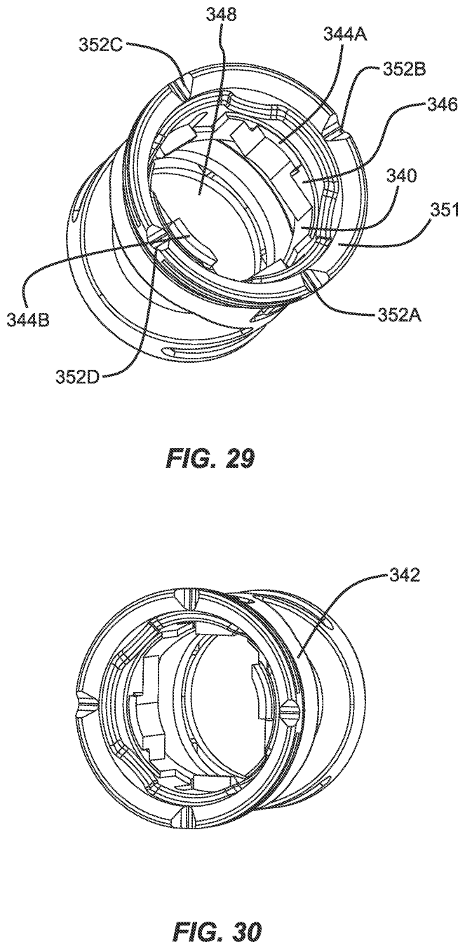

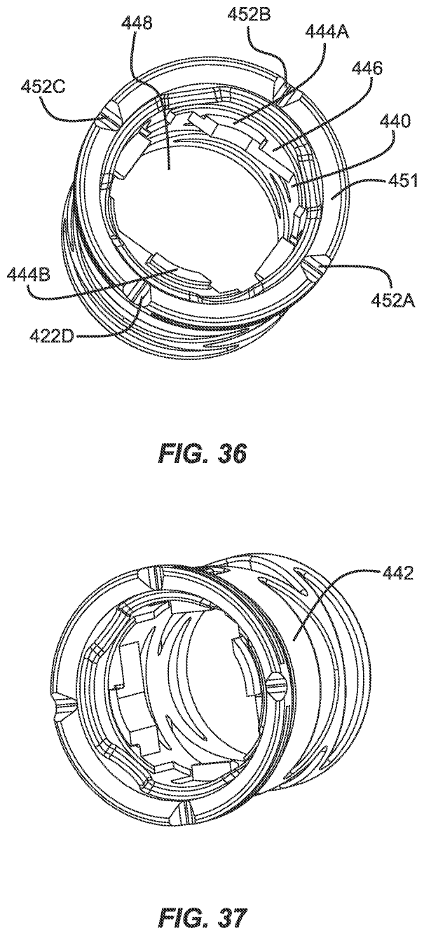

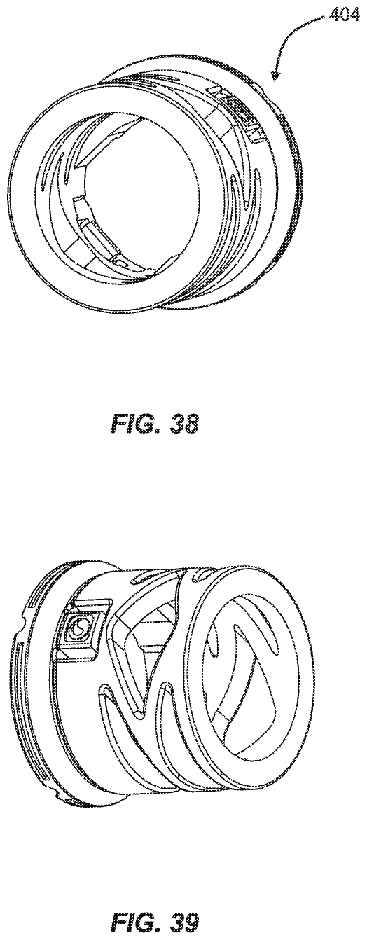

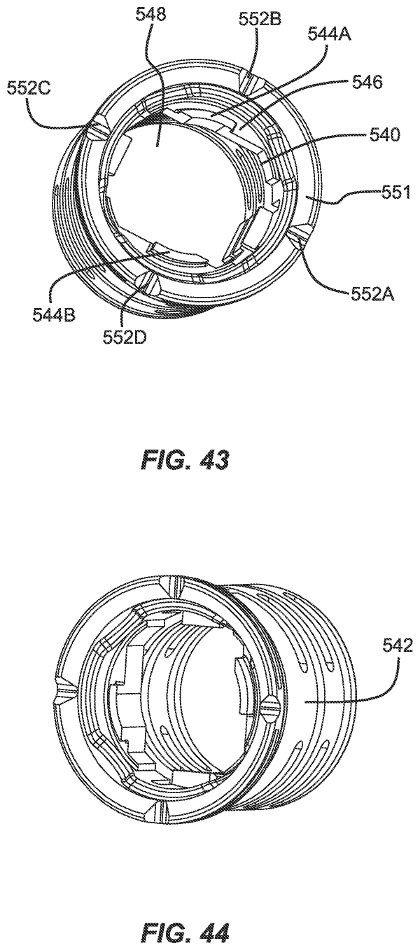

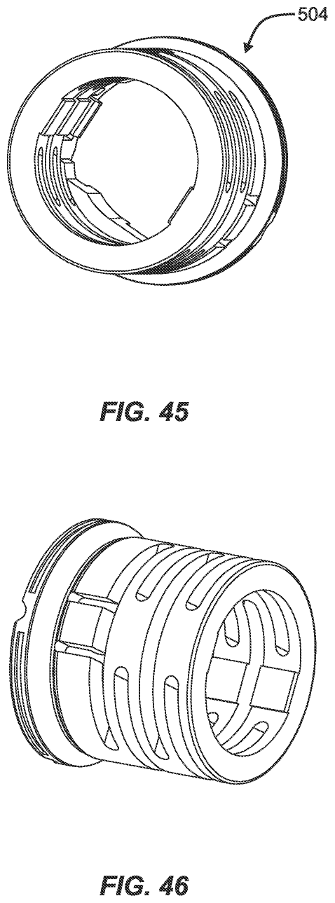

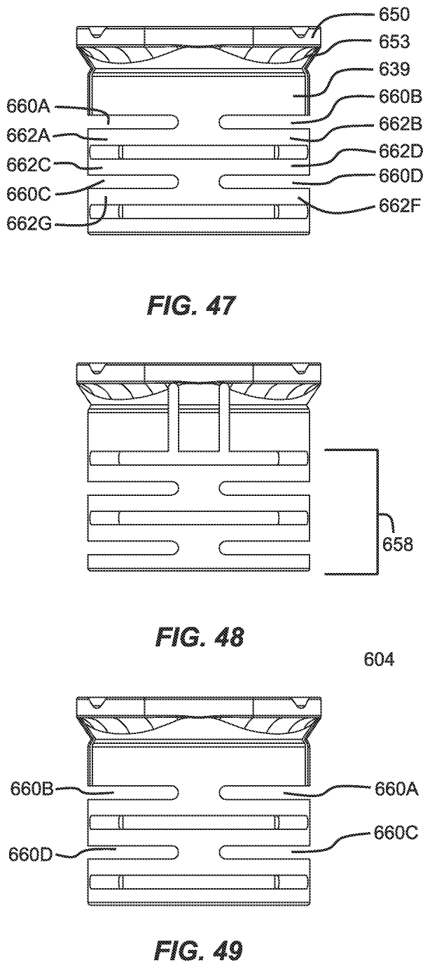

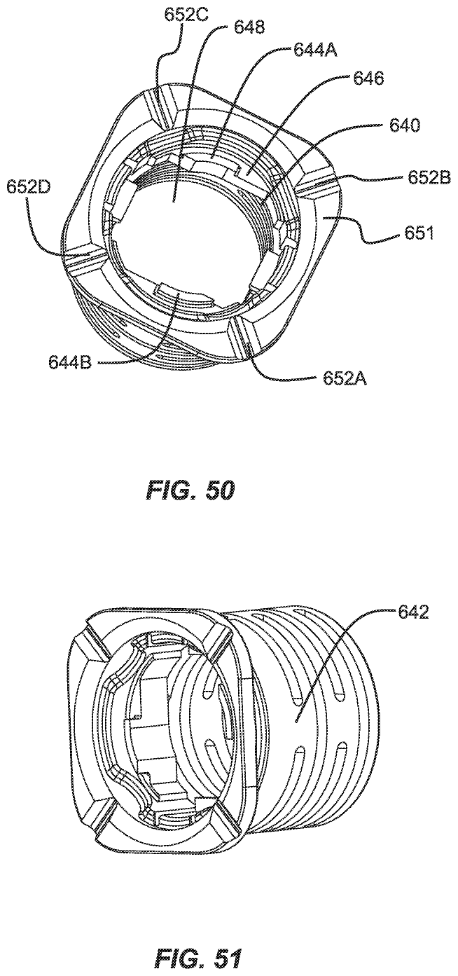

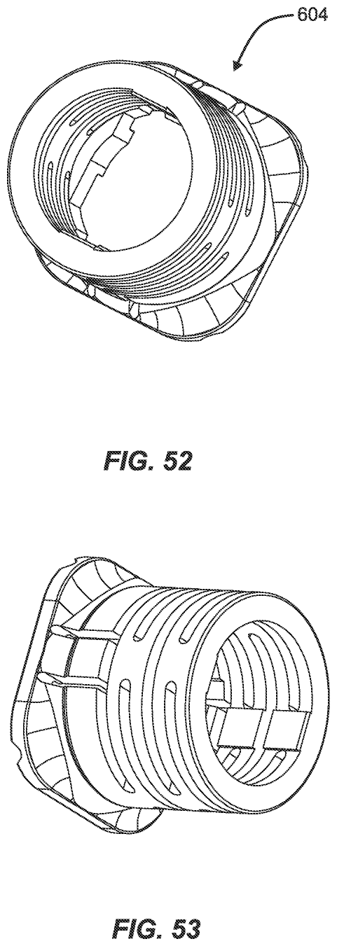

With additional reference to FIGS. 19-53, in embodiments, the retention spring collar 204, 304, 404, 504, 604 can be generally configured as a cylindrical tube 239, 339, 439, 539, 639 defining an interior wall 240, 340, 440, 540, 640 and an exterior wall 242, 342, 442, 542, 642. The interior wall 240, 340, 440, 540, 640 can define one or features 244A/B, 344A/B, 444A/B, 544A/B, 644A/B configured to interact with the keyed distal end 74 of the ruggedized connector 50. For example, the one or more features 244A/B, 344A/B, 444A/B, 544A/B, 644A/B can define shaped pins or protrusions that mirror the ramp and stop surfaces, 67, 68 of the distal end 74. In some embodiments, one or more features 244A/B, 344A/B, 444A/B, 544A/B, 644A/B can extend distally from a ridge 246, 346, 446, 546, 646 traversing at least partially around the interior wall 240, substantially orthogonal to a longitudinal axis of the retention spring collar 204, 304, 404, 504, 604. In some embodiments, the ridge 246, 346, 446, 546, 646 can define an opening 248, 348, 448, 548, 648 (e.g., similar to the shape of the mounting opening) into which a portion of the main adapter body 202 can be positioned.

If it is desired to decouple the ruggedized connector 50 from the adapter assembly 200, the retention spring collar 204, 304, 404, 504, 604 must be manually shifted from an extended position to the retracted position, thereby shifting the one or more features 244A/B, 344A/B, 444A/B, 544A/B, 644A/B out of interfering contact with the stop surfaces 68 of the distal end 74. Thereafter, the ruggedized connector 50 can be rotated from the interlock position to the non-interlocked position (e.g., against the resistance of the first interlock function, thereby enabling removal of the ruggedized connector 50 from the adapter assembly 200.

To aid in shifting the retention spring collar 204, 304, 404, 504, 604 from the extended position to the retracted position, in some embodiments, the retention collar 204, 304, 404, 504, 604 can define a flange 250, 350, 450, 550, 650, which can be positioned circumferentially around a distal end of the retention spring collar 204, 304, 404, 504, 604. In particular, in some embodiments, the flange 250, 350, 450, 550, 650 can extend radially outward from the exterior wall 242, 342, 442, 542, 642 of the retention spring collar 204, 304, 404, 504, 604, so as to establish a larger end surface area 251, 351, 451, 551, 651 for manipulation of the retention spring collar 204. In an effort to reduce sharp angles and for improved structural stability, in some embodiments, the flange 250, 350, 450, 550, 650 can be operably coupled to the exterior wall 242, 342, 442, 542, 642 by a sloped or ramped surface 253, 353, 453, 553, 653, which can transition the exterior wall 242, 342, 442, 542, 642 from a smaller diameter portion to a larger diameter portion. Further, in some embodiments, the end surface area 651 can be generally shaped in a rectangular or other polygon format for an increased surface area.

To further aid in manipulation of the retention spring collar 204, 304, 404, 504, 604, in some embodiments, the flange 250, 350, 450, 550, 650 can define a plurality of flats or grooves 252, 352, 452, 552, 652 spaced around a perimeter of the flange 250, 350, 450, 550, 650, which in some embodiments can aid the user in manipulation of the retention spring collar 204. For example, in some embodiments, the flange 250, 350, 450, 550, 650 can define four grooves 252A-D, 352A-D, 452A-D, 552A-D, 652A-D, although a greater or fewer number of grooves or flats are also contemplated. As an additional aid, in some embodiments, the flange 250, 350, 450, 550, 650 can define a ridge or channel 255, 355, 455, 555 positioned circumferentially at least partially around the an exterior radial surface of the flange 250, 350, 450, 550, 650.

In practice, the grooves 252A-D, 352A-D, 452A-D, 552A-D, 652A-D can enable user to use a tool (e.g., a flat head screwdriver or the like) to move the retention spring collar 204, 304, 404, 504, 604 from the extended position to the retracted position for removal of the ruggedized connector 50 from the adapter assembly 100, particularly with the retention spring collar 204, 304, 404, 504, 604 may be positioned in a crowded environment where finger clearance may be an issue. In such cases, a user can grip and rotate the strain relief boot 64 of the ruggedized connector 50, which can turn in unison with the fastener 62 of the ruggedized connector 50, thereby releasing the ruggedized connector 50 from the adapter assembly 100.

In some embodiments, the cylindrical tube 239, 339, 439, 539, 639 defining the interior wall 240, 340, 440, 540, 640 and the exterior wall 242, 342, 442, 542, 642 can define a spring portion 258, 358, 458, 558, 658, which as depicted in FIGS. 19-53, can rely on a natural resiliency of the material forming the cylindrical tube 239, 339, 439, 539, 639, with portions of the cylindrical tube 239, 339, 439, 539, 639 removed, such that the cylindrical tube 239, 339, 439, 539, 639 forms one or more spring arms 262A/B, 362A/B, 462A-D, 562A-F, 662A-F. In some embodiments, the one or more spring arms 262A/B, 362A/B, 462A-D, 562A-F, 662A-F can extend radially outward from the longitudinal axis of the retention spring collar 204, 304, 404, 504, 604 at angle (e.g., an angle equal to about 90°, 100°, 110°, 120°, 130°, 140°, etc., wherein about means +/−5°). In other embodiments, the one or more spring arms 262A/B, 362A/B, 462A-D, 562A-F, 662A-F can traverse across the cylindrical tube, so as to be positioned at an angle relative to the longitudinal axis of the retention spring collar 204, 304, 404, 504, 604. In embodiments, the retention spring collar 204, 304, 404, 504, 604 can be constructed of a unitary, single piece, monolithically formed structure including both the one or more spring arms 262A/B, 362A/B, 462A-D, 562A-F, 662A-F and the flange 250, 350, 450, 550, 650.

As depicted in FIGS. 19-25, 26-31 & 32-38, in embodiments, the cylindrical tube 239, 339, 439 can be defined as a substantially continuous hollow cylindrical structure in which a plurality of wedge portions 260A-C, 360A-F, 460A-D are omitted, thereby defining a first spring arm 262A, 362A, 462A, a second spring arm 262B, 362B, 462B, and an optional third and fourth spring arm 462C, 462D.

As depicted in FIGS. 19-25, the first and second spring arms 262A/B are formed as arcuate segments of a cylindrical tube. In one embodiment, the first spring arm 262A has a first end operably coupled to a base 272 of the retention spring collar 200 and a second end operably coupled to a second end of the second spring arm 262B, and the first end of the second spring arm 262 is operably coupled to the flange 250.

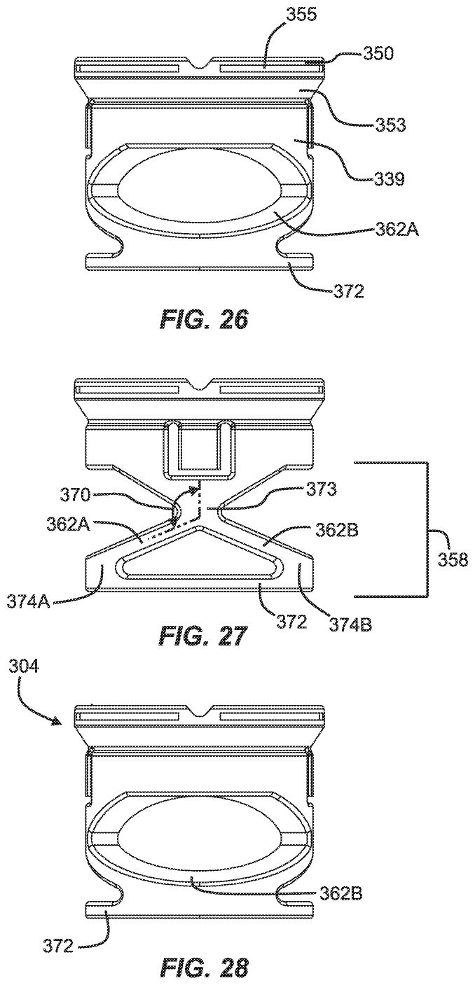

As depicted in FIGS. 26-32, the first and second spring arms 362A/B are formed as arcuate segments of a cylindrical tube. In one embodiment, the first and second spring arms 362A/B have first and second ends operably coupled to one another to form a continuous loop. In one embodiment, the first and second ends of the first and second spring arms 362A/B are operably coupled to the flange 350. In one embodiment, a portion 374A/B on the first and second spring arms 362A/B positioned between the first and second ends can be operably coupled to the base 372.

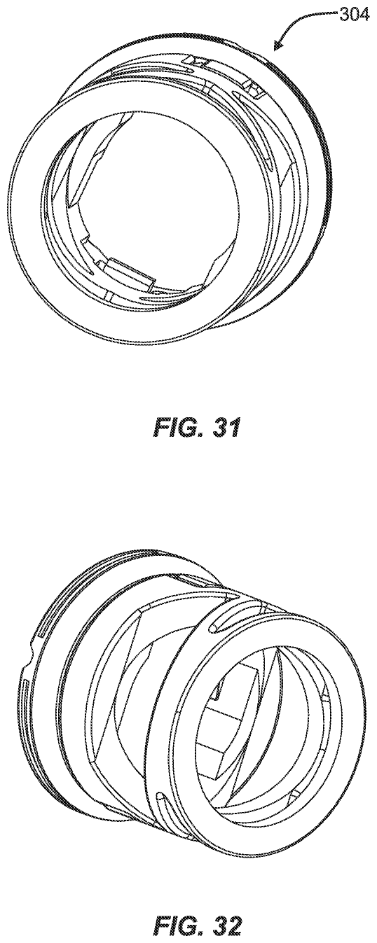

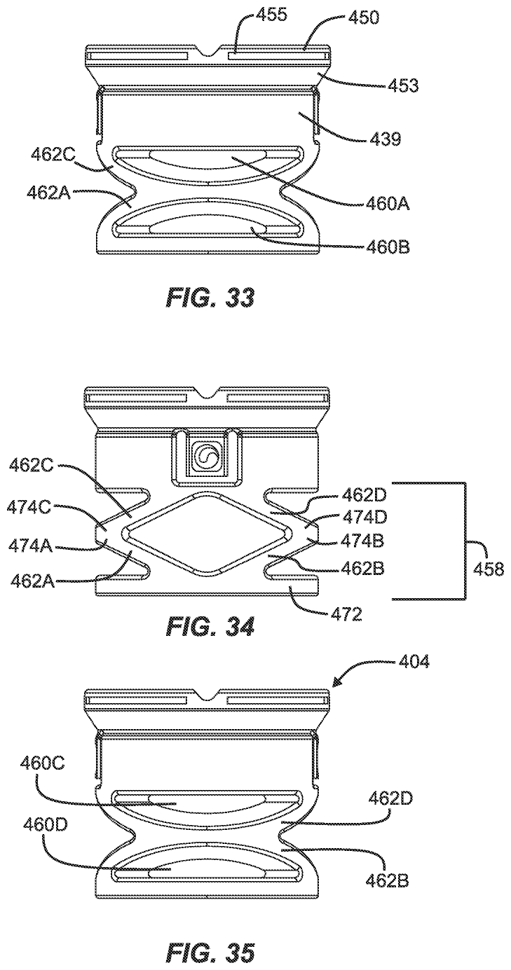

As depicted in FIGS. 33-39, the spring arms 462A-D are formed as arcuate segments of a cylindrical tube. In one embodiment, the first and second spring arms 462A/B have first and second ends operably coupled to one another to form a continuous loop. In one embodiment, the first and second ends of the first and second spring arms 462A/B are operably coupled to the base 472. In one embodiment, a portion 474A/B on the first and second spring arms 462A/B positioned between the first and second ends can be operably coupled to a corresponding portion 474C/D positioned between the first and second ends of the third and fourth spring arms 462C/D. In one embodiment, the first and second ends of the third and fourth spring arms 462C/D are operably coupled to one another to form a continuous loop. In one embodiment, the first and second ends of the third and fourth spring arms 462C/D are operably coupled to the flange 450.

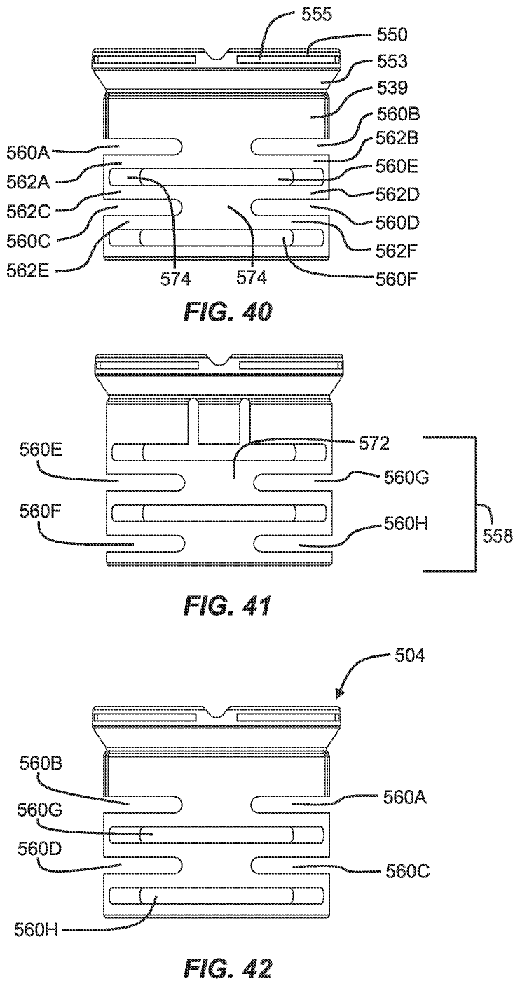

As depicted in FIGS. 40-46 & 47-53, in embodiments, the cylindrical tube 539, 639 can be defined as a substantially continuous hollow cylindrical structure in which a plurality of lateral portions 560A-H, 660A-H are omitted, thereby defining a first spring arm 562A, 662A, a second spring arm 562B, 662B, a third spring arm 562C, 662C, a fourth spring arm 562D, 662D, a fifth spring arm 562E, 662E, and a sixth spring arm 562F, 662F. As depicted in FIGS. 40-46 & 47-53, the spring arms 562A-F, 662A-F are formed as arcuate segments of a cylindrical tube traversing at least partially around the cylindrical tube in a radial direction.

In one embodiment, the first and second spring arms 562A/B, 662A/B have first and second ends operably coupled to one another to form a continuous loop. In one embodiment, the first and second ends of the first and second spring arms 562A/B, 662A/B are operably coupled to the flange 550, 650. In one embodiment, a portion 574, 674 on the first and second spring arms 562A/B, 662A/B positioned between the first and second ends is coupled to first and second ends of the third and fourth spring arms 562C/D, 662C/D. In one embodiment, a portion 574, 674 on the third and fourth spring arms 562C/D, 662C/D positioned between the first and second ends is coupled to first and second ends of the fifth and sixth spring arms 562E/F, 662E/F.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A fiber optic adapter assembly comprising:
a main body having a first end defining a ruggedized connector port and a second end defining a non-ruggedized connector port; and
a retention collar configured to mount over an exterior of the main body, wherein one or more features defined by the retention collar interact with a coupling arrangement inserted into the retention collar to shift the retention collar axially relative to the main body from an extended position to a retracted position, whereupon rotation of the coupling arrangement relative to the retention collar from a non-interlocked position to an interlocked position, the retention collar is shiftable axially relative to the main body back to the extended position, thereby inhibiting back rotation of the coupling arrangement from the interlocked position to the non-interlocked position.

2. The fiber optic adapter assembly of claim 1, wherein the one or more features defined by the retention collar include one or more shoulders extending distally from a ridge oriented substantially orthogonal to a longitudinal axis of the retention collar and traversing at least partially around the interior wall of the retention collar.

3. The fiber optic adapter assembly of claim 2, wherein main body defines one or more stops including ramp surfaces configured to initially align the one or more shoulders with one or more push surfaces of the coupling arrangement.

4. The fiber optic adapter assembly of claim 3, wherein initially alignment of the one or more shoulders with one or more push surfaces of the coupling arrangement positions the one or more stops in one or more respective gaps defined between adjacent projections on an interior surface of the coupling arrangement.

5. The fiber optic adapter assembly of claim 4, wherein the one or more stops are radially positioned to at least partially overlap with the one or more shoulders.

6. The fiber optic adapter assembly of claim 5, wherein each of the one or more shoulders span a first radial angle of between about 15° and about 45° or less, and each of the one or more stops span a second radial angle of between about 5° and about 30° or less, and wherein the first radial angle at least partially overlaps with the second radial angle to enable the one or more stops to initially align the one or more shoulders with one or more push surfaces of the coupling arrangement.

7. The fiber optic adapter assembly of claim 1, further comprising a biasing element configured to bias the retention collar to the extended position.

8. The fiber optic adapter assembly of claim 7, wherein the biasing element comprises a coil spring.

9. The fiber optic adapter assembly of claim 1, wherein the retention collar defines a flange positioned on a distal end of the retention collar to aid manipulation of the retention collar from the extended position to the retracted position.

10. The fiber optic adapter assembly of claim 9, wherein the flange defines one or more grooves to further aid in manipulation of the retention collar.

11. The fiber optic adapter assembly of claim 1, wherein the one or more features are keyed to mirror a keyed distal end of the coupling arrangement, such that rotation of the coupling arrangement relative to the retention collar enables the one or more features to slide axially relative to the keyed distal end of the coupling arrangement.

12. The fiber optic adapter assembly of claim 2, further comprising one or more anti-rotation tabs extending proximally from the ridge, the one or more anti-rotation tabs configured reside within one or more channels defined by the main body to inhibit rotation of the retention collar relative to the main body.

13. The fiber optic adapter assembly of claim 1, wherein the main body is of a one-piece molded construction.

14. The fiber optic adapter assembly of claim 1, wherein the non-ruggedized connector port is adapted to receive at least one of a non-ruggedized SC or LC connector.

15. The fiber optic adapter assembly of claim 1, wherein the ruggedized connector port is adapted to receive a ruggedized connector of a fiber optic cable.

16. The fiber optic adapter assembly of claim 1, wherein the ruggedized connector port provides a first interlock function and a second interlock function.

17. The fiber optic adapter assembly of claim 16, wherein first interlock function includes a snap-fit feature adapted to engage with a ramped snap-fit feature of a connector of a fiber optic cable, wherein as a portion of the connector is rotated relative to the fiber optic adapter, the ramped snap-fit feature of the connector rides over the snap-fit feature of the fiber optic adapter causing the feature to deflect radially inwardly to allow the ramped snap-fit feature to move past the snap-fit feature, whereupon the connector reaches a coupled rotational position and the ramped snap-fit feature moves past the snap-fit feature such that the snap-fit feature elastically returns to its non-deflected position.

18. The fiber optic adapter assembly of claim 17, wherein the snap-fit feature is a permanent interlock, requiring the snap-fit feature to be broken to rotate a portion of a connector of a fiber optic cable from the interlocked position to the non-interlocked position.

19. The fiber optic adapter assembly of claim 17, wherein the snap-fit feature is a multi-use interlock configured to deform without breaking to allow movement of a portion of a connector of a fiber optic cable from the interlocked position to the non-interlocked position.

20. The fiber optic adapter assembly of claim 16, wherein the second interlock function includes a plurality of triangular projections spaced uniformly along the circumference of the first end.

21. The fiber optic adapter assembly of claim 1, wherein the main body includes a flange and an exterior threaded portion, wherein the mounting opening is defined through a wall, and wherein when the main body is mounted within the mounting opening, the wall is compressed between the flange and a nut threaded on the exterior threaded portion.

22. The fiber optic adapter assembly of claim 21, further comprising a seal positionable between the flange and the wall.

23. The fiber optic adapter assembly of claim 1, further comprising a dust cap adapted to be secured over the first end of the main body to selectively enclose the ruggedized connector port.

24. The fiber optic adapter assembly of claim 1, wherein the main body defines a keyway for receiving an elongate key defined by a portion of a connector of a fiber optic cable.

25. The fiber optic adapter assembly of claim 24, wherein the keyway is defined by two helical shoulders that rotate in opposite helical directions about a central longitudinal axis of the main body.

26. The fiber optic adapter assembly of claim 25, wherein the helical shoulders provide for rotational guiding of a portion of a connector of a fiber optic cable as the connector is inserted into the ruggedized connector port along a rotational range of movement of at least about 135 degrees 180 degrees, 170 degrees, 135 degrees, 90 degrees, 45 degrees, or 30 degrees.

27-40. (canceled)
